(19) United States
(12) Patent Application Publication
(10) Pub. No.: US 2007/0177027 A1
(43) Pub. Date: Aug. 2, 2007

(54) Imaging system and process for rendering the resolution of images high

(75) Inventors: Tomoyuki Nakamura, Cambridge, MA (US); Takahiro Yano, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, TOKYO JAPAN (JP)

(21) Appl. No.: 11/628,910

(22) PCT Filed: Jun. 9, 2005
(86) PCT No.: PCT/JP05/10992

§ 371 Date: Jan. 19, 2007

(30) Foreign Application Priority Data
Jun. 10, 2004 (JP) 2004-172093

(51) Int. Cl. H04N 5/228

(52) U.S. Cl. 348/222.1

(57) ABSTRACT

An optical system (101) forms an optical image on an imager (102), the image is made spatially discrete for transformation into a sampled image signal, and the image signal is separated at a band separation processing block (105) into a high-frequency component and a low-frequency component. At a super-resolution target frame selection block (106), a frame to which super-resolution processing is to be applied is selected out of the separated low-frequency component image for forwarding to an interpolation and enlargement processing block (109). super-resolution processing is implemented by a motion estimation block (107) and a high-resolution image estimation block (108) adapted to estimate image date having a pixel sequence at a high resolution. At a high-resolution image computation area determination block (112), an area in the image, to which high-resolution image estimation computation is to be applied, is determined, and the output of the high-resolution image estimation computation block (108) is forwarded to a combining computation processing block (110).

### ART FIELD

The present invention relates to an imaging system and a process for rendering the resolution of images high, which enable high-resolution images to be acquired from two or more low-resolution images.

### BACKGROUND ART

Imaging techniques capable of combining together images having multiple frames displaced into a high-resolution image have been proposed for use with imaging systems such as video cameras. To generate a high-resolution image from two or more low-resolution images, it is necessary to detect mutual displacements of low-resolution images with precision of less than a pixel unit (often called the sub-pixel hereinafter).

To diminish the quantity of computation to this end, for instance, JP(A)10-69537 shows that the structural analysis of an image is implemented in terms of the features of each object in the image and relative positions of objects, and then relative displacements between frame images are detected from correlations of structural information to render the resolution of the image high.

With the technique set forth in JP(A)10-69537, however, there is a problem that it must have a structural analysis means for a subject as a part of the image processing means, resulting in an increase in the magnitude of processing circuitry. Another problem is that it is required to have some understanding of information about the structure of the subject beforehand, resulting in some limitation to the type of compatible subjects.

In view of such problems with the prior art as described, an object of the present invention is to provide an imaging system and a process for rendering the resolution of an image high, wherein by subjecting an image to band separation, the calculation of the quantity of displacements between images (called motion hereinafter) and high-resolution processing can be efficiently implemented.

### DISCLOSURE OF THE INVENTION

(1) The first embodiment of the invention for accomplishing the aforesaid object provides an imaging system for electronically obtaining an image of a subject, characterized by comprising an optical image-formation means adapted to form the image of the subject, a means adapted to make an optically formed image into a spatially sampled discrete image signal, a means adapted to separate the sampled image signal into multiple component image signals by a spatial frequency, a means adapted to apply interpolation and enlargement processing to a low frequency component image separated by the spatial frequency, a means adapted to estimate a relative displacement of the subject between frames, a means adapted to make from multiple frames a frame to which high-resolution image estimation processing is to be applied, a high-resolution image estimation means adapted to estimate a high-resolution image from high-frequency component images each separated from image signals of multiple frames, and a means adapted to combine an interpolated and enlarged image with an image subjected to high-resolution image estimation processing.

The invention (1) is equivalent to the first embodiment shown in FIG. 1.

The “optical image-formation means adapted to form an image of a subject” is equivalent to an optical system 101. The “means adapted to make an optically formed image into a spatially sampled discrete image signal” is equivalent to an imager 102. The “means adapted to separate the sampled image signal into multiple component image signals by a spatial frequency” is equivalent to a band separation processing block 105. The “means adapted to apply interpolation and enlargement processing to a low frequency component image separated by the spatial frequency” is equivalent to an interpolation and enlargement processing block 109. The “means adapted to estimate a relative displacement of the subject between frames” is equivalent to a motion estimation block 107. The “means adapted to select from multiple frames a frame to which high-resolution image estimation processing is to be applied” is equivalent to a super-resolution target frame selection block 106. The “high-resolution image estimation means adapted to estimate a high-resolution image from high-frequency component images each separated from image signals of multiple frames” is equivalent to a high-resolution image estimation block 108. The “means adapted to combine an interpolated and enlarged image with an image subjected to high-resolution image estimation processing” is equivalent to a combining computation processing block 110.

According to the architecture of the invention (1), image signals processed through the means adapted to separate the sampled image signal into multiple component image signals by a spatial frequency are processed by the high-resolution image estimation means. There is thus no need of implementing for all image data high-resolution image estimation processing on which there are heavy computation loads; the quantity of computation can be diminished, making sure fast processing.

(2) The aforesaid invention (1) is further characterized in that said sampled image signal is entered in said means adapted to estimate a relative displacement of the subject between frames.

The invention (2) is equivalent to a modification to the first embodiment, as shown in FIG. 7. That is, as shown in FIG. 7, the image signal sampled at the imager 102 is entered in the means adapted to estimate a relative displacement of the subject between frames before it is subjected to band separation at the band separation processing block 105. It is thus possible to estimate the relative displacement of the subject between frames with respect to all high- and low-frequency components of the image signal sampled at the imager 102, making high the accuracy with which the displacement is estimated.

(3) The aforesaid invention (1) is further characterized in that said means adapted to estimate a relative displacement of the subject between frames uses an image signal of at least one component separated into said multiple component image signals to estimate a relative displacement of the subject between frames. The invention (3) is equivalent to the first embodiment shown in FIG. 1. At least one component image signal of the multiple component image signals separated at the band separation processing block 105 is used to estimate a relative displacement of the subject between frames. According to this architecture, an appropriate component image signal of the multiple component image signals separated at the band separation processing block 105 is entered in the motion estimation block 107 so that a relative displacement of the subject between frames can be estimated.

(4) The second embodiment of the invention provides an imaging system for electronically obtaining an image of a subject, characterized by comprising an optical image-formation means adapted to form the image of the subject, a means adapted to make an optically formed image into a spatially sampled discrete image signal, a means adapted to separate the sampled image signal into multiple component image signals by a spatial frequency, a means adapted to estimate a relative displacement of the subject between frames, an image storage means adapted to provide a temporal storage of the image signal, a means adapted to select from multiple frames a frame to which high-resolution image estimation processing is to be applied, a high-resolution image estimation means adapted to estimate a high-resolution image from image signals of multiple frames, an image information identification means adapted to refer to at least one image signal of multiple component image signals separated by said spatial frequency to identify image information, and a means adapted to use information about the image identified by said image information identification means to set an area in an image, wherein information about said area in an image is used to estimate a high-resolution image.

The invention (4) is equivalent to the first embodiment shown in FIG. 2. The “optical image-formation means adapted to form an image of a subject” is equivalent to an optical system 101. The “means adapted to make an optically formed image into a spatially sampled discrete image signal” is equivalent to an imager 102. The “means adapted to separate the sampled image signal into multiple component image signals by a spatial frequency” is equivalent to a band separation processing block 105. The “means adapted to estimate a relative displacement of the subject between frames” is equivalent to a motion estimation block 107. The “means adapted to provide a temporal storage of the image signal” is equivalent to a memory block 113. The “means adapted to select from multiple frames a frame to which high-resolution image estimation processing is to be applied” is equivalent to a super-resolution target frame selection block 106. The “high-resolution image estimation means adapted to estimate a high-resolution image from a high-frequency component of multiple frame image signals” is equivalent to a high-resolution image estimation block 108. The “image information identification means adapted to refer to at least one image signal of multiple component image signals separated by said spatial frequency to identify image information” and the “means adapted to use the image information identified by said image information identification means to set an area in an image” are equivalent to a processing area determination block 114.

According to the invention (4), the magnitude of processing can be diminished, because there is no need of using the means for interpolating and enlarging a low-frequency component of the image separated by the spatial frequency, the means for determining from the image signal the area to which high-resolution processing is to be applied, and the means for combining the interpolated and enlarged image with the image to which the high-resolution image estimation processing is applied in the aforesaid invention (1).

(5) The invention (4) is further characterized in that said image information identification means is a means adapted to extract a high-frequency component from the image. At the processing area determination block 114 that is equivalent to the “image information identification means”, only information having a high-frequency component is identified from the image separated into a high-frequency component and a low-frequency component. According to this architecture, motion estimation is made by use of only some part of the image containing a lot more high-frequency component, and that is used as a motion for the whole image to implement high-resolution image estimation computation.

(6) The aforesaid invention (4) is further characterized in that said image information identification means is adapted to refer to luminance information of at least one image signal of said multiple component image signals separated by said spatial frequency. The “image information identification means being adapted to refer to luminance information of at least one image signal of said multiple component image signals separated by the spatial frequency” is equivalent to a processing area determination block 114. According to this architecture, an area containing a lot more high-frequency component can be determined and cut out of the luminance information for forwarding to a motion estimation block 107.

(7) A process for reconstructing a high resolution image according to the first embodiment of the invention is a process for reconstructing a high resolution image from sampled image signals, characterized by comprising the steps of separating the sampled image signal into multiple component image signals by a spatial frequency, applying interpolation and enlargement processing to a low-frequency component image separated by the spatial frequency, estimating a relative displacement between frames by a displacement estimation means, selecting from multiple frames a frame to which high-resolution image estimation processing is to be applied, estimating a high-resolution image from high-frequency component images each separated from image signals of multiple frames, and combining an interpolated and enlarged image with an image to which high-resolution image estimation processing is applied.

The invention (7) is equivalent to a process for making the resolution of an image high shown in the architecture diagram of FIG. 1. The “step of separating the sampled image signal into multiple component image signals by a spatial frequency” is equivalent to processing by the band separation processing block 105. The “step of applying interpolation and enlargement processing to a low-frequency component image separated by a spatial frequency” is equivalent to processing by the interpolation and enlargement processing block 109. The “step of estimating a relative displacement between frames by a displacement estimation means” is equivalent to processing by the motion estimation block 107. The “step of selecting from multiple frames a frame to which high-resolution image estimation processing is to be applied” is equivalent to processing by the super-resolution target frame selection block 106. The “step of estimating a high-resolution image from high-frequency component images each separated from multiple frame image signals” is equivalent to processing by the high-resolution image estimation block 108. The “step of combining an interpolated and enlarged image with an image to which high-resolution image estimation processing is applied” is equivalent to the combining computation processing block 110.

According to the invention (7), when the high-resolution image estimation processing is implemented on software, the speed of computation can be improved because of no need of implementing processing for all images.

(8) The aforesaid invention (7) is further characterized in that said sampled image signal is entered in the displacement estimation means adapted to estimate a relative displacement of the subject between frames. The invention (8) is equivalent to a modification to the first embodiment, wherein making the resolution of an image high is implemented as shown in FIG. 8. According to this architecture, when high-resolution image estimation processing is implemented on software, the accuracy with which the displacement is estimated can be improved.

(9) The aforesaid invention (7) is further characterized in that said step of estimating a relative displacement of the subject between frames uses an image signal of at least one component separated into said multiple component image signals to estimate a relative displacement of the subject between frames. The invention (9) is equivalent to the process for making the resolution of an image high, shown in the architecture diagram of FIG. 1. With this architecture, when high-resolution image estimation processing is implemented on software, it is possible to estimate a relative replacement of the subject between frames with respect to an appropriate component image signal of an image signal separated into multiple components.

(10) A process for reconstructing a high resolution image according to the second embodiment of the invention is a process for reconstructing a high resolution image signal from sampled image signals, characterized by comprising the steps of separating the sampled image signals into multiple component image signals by a spatial frequency, estimating a relative displacement between frames, providing a temporal storage of an image signal, selecting from multiple frames a frame to which high-resolution image estimation processing is to be applied, estimating a high-resolution image from image signals of multiple frames, referring to at least one image signal of said multiple component image signals separated by the spatial frequency to identify information about an image by an identification means, and setting an area in an image by said identification means, wherein said step of estimating a high-resolution image uses an area about said area in an image to estimate a high-resolution image.

The invention (10) is equivalent to the process for making the resolution of an image high, shown in the architecture diagram of the second embodiment shown in FIG. 14. The “step of separating the sampled image signals into multiple component image signals by a spatial frequency” is equivalent to processing by the band separation processing block 105. The “step of estimating a relative displacement between frames” is equivalent to processing by the motion estimation block 107. The “step of providing a temporal storage of an image signal” is equivalent to processing by the memory block 113. The “step of selecting from multiple frames a frame to which high-resolution image estimation processing is applied” is equivalent to processing by the super-resolution target frame selection block 106. The “step of estimating a high-resolution image from high-frequency component images from multiple frame image signals” is equivalent to processing by the high-resolution image estimation block 108. The “step of referring to at least one image signal of said multiple component image signals separated by a spatial frequency to identify image information by an identification means” and the step of setting an area in an image by said identification means” are equivalent to processing by the processing area determination block 114. According to the invention (10), when making the resolution of an image high is implemented on software, the speed of processing can be much faster.

(11) The aforesaid invention (10) is further characterized in that at said step of identifying said information about an image, a high-frequency component is extracted from the image. With this architecture, when high-resolution image estimation processing is implemented on software, high-resolution image estimation computation can be implemented by motion estimation using only some area of the image containing a lot more high-frequency component.

(12) The aforesaid invention (10) is further characterized in that at said step of identifying said information about an image, reference is made to luminance information of at least one image signal of multiple component image signals separated by the spatial frequency. This processing is equivalent to processing by the processing area determination block 114. With this architecture, when high-resolution image estimation processing is implemented on software, an area containing a lot more high-frequency component is determined from and cut out of the luminance information, so that the relative displacement between frames can be estimated at the motion estimation block.

With the imaging system of the invention and the process for making the resolution of an image high according to the invention, high-resolution image estimation computation and the motion estimation computation needed for it can be implemented with high efficiency.

### BRIEF DESCRIPTION OF THE DRAWINGS

FIG. 1 is illustrative of the architecture of the first embodiment of the invention.

FIG. 2 is illustrative of the architecture of the band processing block.

FIG. 3 is illustrative of an image before band separation processing is applied.

FIG. 4 is illustrative of the image of FIG. 3 to which low-pass filtering is applied.

FIG. 5 is illustrative of the image of FIG. 4 to which the processing of 1052 and 1053 is applied.

FIG. 6 is a characteristic diagram for the tone histogram of the image of FIG. 5.

FIG. 7 is illustrative of the architecture of a modification to the embodiment of the first invention.

FIG. 8 is a flowchart for the motion estimation algorithm.

FIG. 9 is illustrative in conception of estimation of the optimal similarity of motion estimation.

FIG. 10 is illustrative in conception of high-resolution image computation area determination.

FIG. 11 is a flowchart for the high-resolution image estimation processing algorithm.

FIG. 12 is illustrative of the architecture of the high-resolution image estimation computation block.

FIG. 13 is illustrative of the combining computation processing block.

FIG. 14 is illustrative of the architecture of the embodiment of the second invention.

### BEST MODE FOR CARRYING OUT THE INVENTION

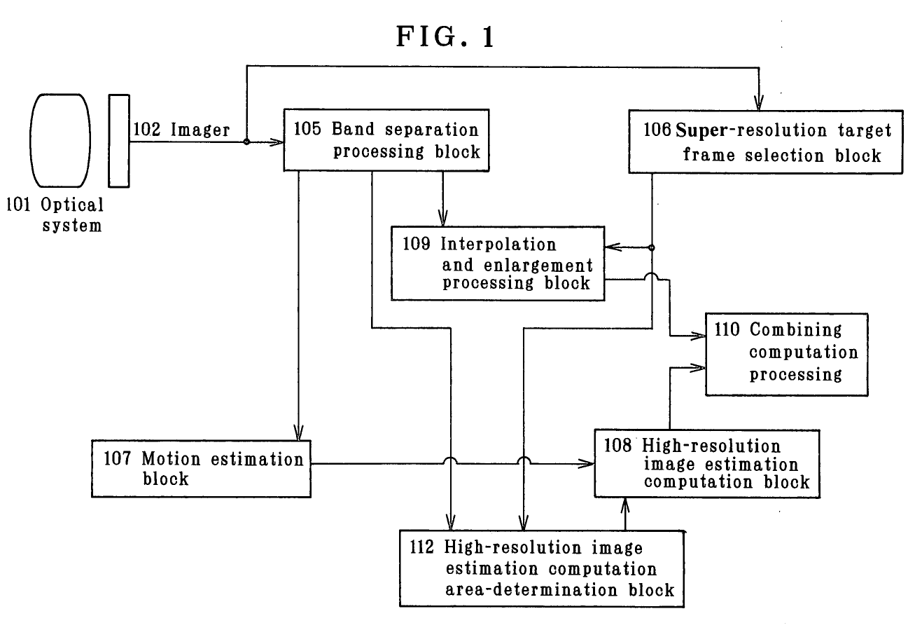

Some embodiments of the invention are now explained with reference to the accompanying drawings. FIG. 1 is illustrative of the architecture of the first embodiment. In FIG. 1, an optical system 101 forms an optical image on an imager 102, and the imager 102 makes an optically formed image spatially discrete for transformation into a sampled image signal. The image signal sampled at the imager 102 is forwarded to a band separation processing block 105, where it is separated by a spatial frequency into a high-frequency component image and a low-frequency component image.

super-resolution processing is implemented by a motion estimation block 107, and a high-resolution image estimation block 108 adapted to estimate image data having a sequence of high-resolution pixels. The high-frequency component image is forwarded to the motion estimation block 107 for super-resolution processing. The super-resolution processing here is a technique wherein two or more images found to have misalignments at the sub-pixel level are taken, and these images are combined into one high-definition image after deterioration factors responsible for the optical system or the like are canceled out of them.

At a super-resolution target frame selection block 106, the target frame to which super-resolution processing is to be applied is selected. Out of the low-frequency component image separated at the band separation processing block 105, a frame corresponding to the target frame to which super-resolution processing is to be applied is selected and forwarded to an interpolation and enlargement processing block 109, which comprises interpolation processing as by bicubic to enlarge the low-frequency component image of the target frame.

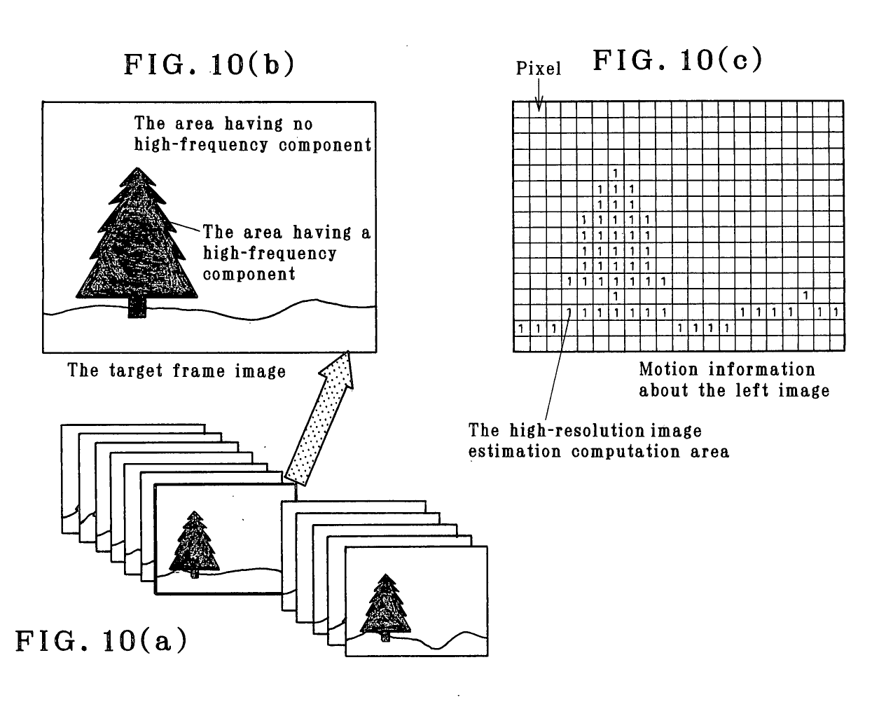

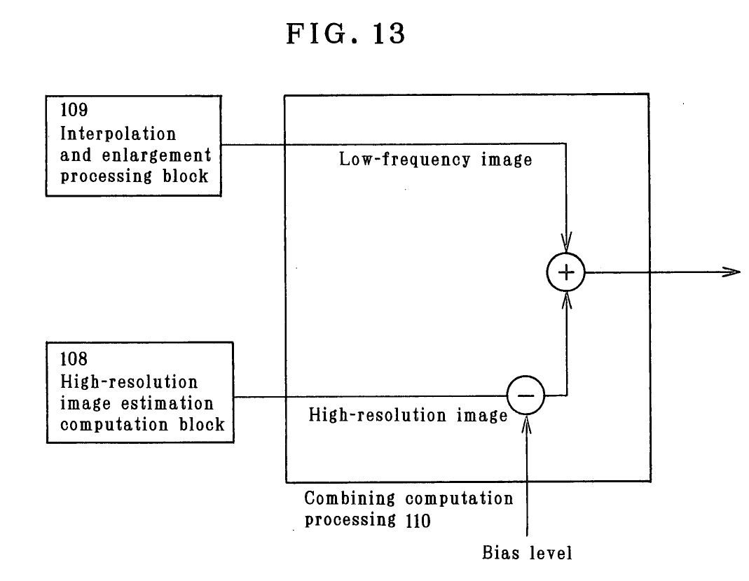

At a high-resolution image computation area-determination block 112, as shown typically in FIG. 10, an area in the image, to which high-resolution image estimation computation processing is to be applied, is determined from the high-frequency component image produced out of the band separation processing block 105 and information about the target frame given out of the super-resolution target frame selection block 106. At the super-resolution image estimation computation block 108, high-resolution image estimation computation is implemented from information about motion for each frame, given out of the motion estimation block 107 and multiple frame image data with computation address information for each area, given out of the high-resolution image estimation computation determination block 112. This ensures that high-resolution image estimation computation is implemented only for the area having a high-frequency component. The architecture of the combining computation processing block 110 will be described later with reference to FIG. 13.

In the architecture of FIG. 1, the optical system 101 forms an optical image on the imager 102, and the imager 102 makes the optically formed image spatially discrete for transformation into the sampled image signal. In the invention, the image signal is not limited to the one acquired at the optical system 101 and imager 102. High-resolution processing for an image could be implemented using a sampled image signal recorded in a suitable recording medium. In this case, the sampled image signal recorded in that recording medium is entered in the band separation processing block 105 and super-resolution image target frame selection block 106. Then, such similar processing as described above may be implemented at the motion estimation block 107, super-resolution image estimation computation block 108, interpolation and enlargement processing block 109, combining computation processing block 110 and high-resolution image computation area-determination block 112. That is, the architecture of FIG. 1 enables an image to have higher resolution according to the invention.

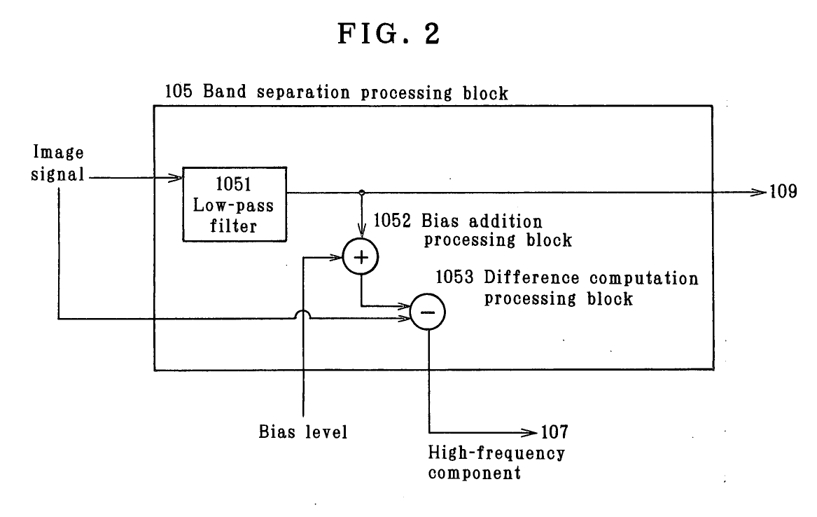

FIG. 2 is illustrative of one example of the architecture of the band separation processing block 105 described with reference to FIG. 1. The image signal produced out of the imager 102 is transformed at a low-pass filtering block 1051 into a low-frequency image, and a frame of the low-frequency component image, selected at the super-resolution target frame selection block 106, is forwarded to the interpolation and enlargement processing block 109. On the other hand, the high-frequency component image applies at a bias addition processing block 1052 predetermined bias processing to an image obtained at the low-pass filtering block 1051 to implement difference computation with respect to the original image at a difference computation processing block 1053. The bias addition processing block 1052 implements nonnegative processing for holding the high-frequency component image in a memory having a predetermined bit width with no sign.

A bias-level signal and a signal from the low-pass filter 1051 are entered in that bias addition processing block 1052, and a signal from the bias addition processing block 1052 and an image signal produced out of the imager 102 of FIG. 1 are entered in the difference computation processing block 1053. Accordingly, a difference between the output signal from the imager 102 and a signal with a bias signal added to a signal obtained upon passing the output signal from the imager 102 through the low-pass filter 1051 is produced out of the difference computation processing block 1053. The output signal from the difference computation processing block 1053 is entered as the high-frequency component image in the motion estimation block 107 of FIG. 1.

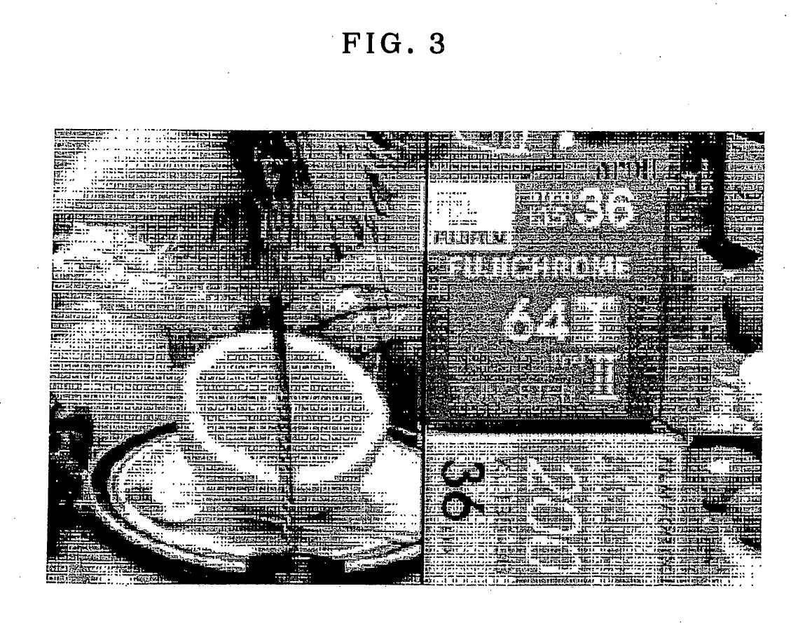

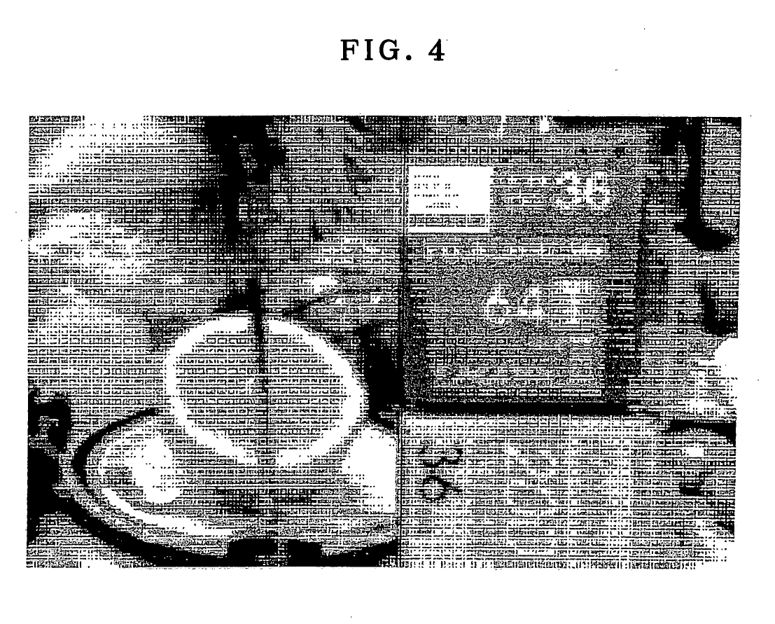

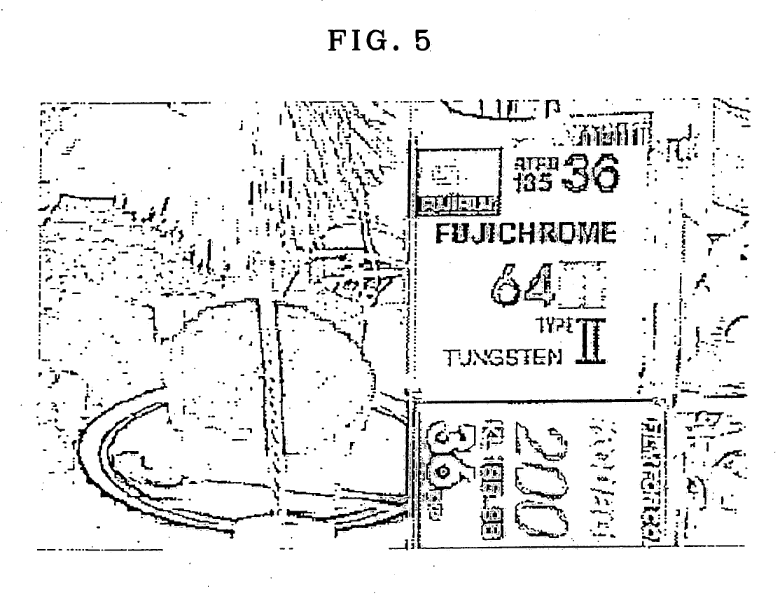

FIGS. 3, 4 and 5 are illustrative of examples of the image wherein the band separation processing is applied to the output signal from the imager 102. FIG. 4 shows an image wherein low-pass filtering is applied to the original image signal (FIG. 3). That is, the image of FIG. 4 is entered in the interpolation and enlargement processing block 109. FIG. 5 shows a high-frequency component image obtained as a result of processing at the bias addition processing block 1052 and difference computation processing block 1053 in FIG. 2.

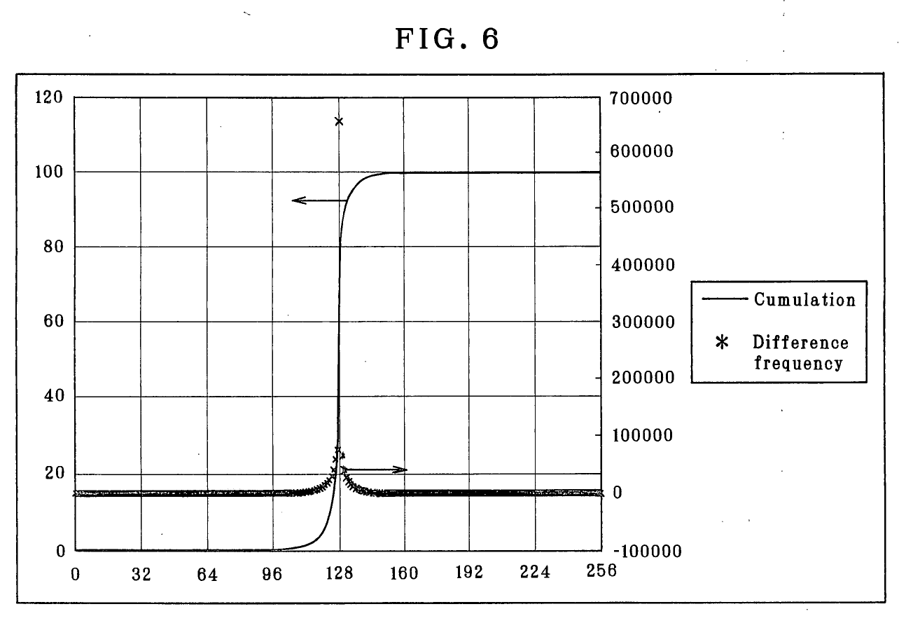

FIG. 6 is a characteristic diagram indicative of the tone histogram of the image of FIG. 5, with an 8-bit image signal as abscissa. In FIG. 6, the left ordinate is indicative of a difference frequency in % and the right ordinate is indicative of the accumulated (absolute) value of a pixel frequency. As can be seen from FIG. 6, there is a peak value for the difference frequency appearing near the center of the 8-bit image signal. As many as 99.6% pixels are contained in 64 shades of gray between 96 and 160 so that a high-frequency component image can be expressed by 6 bits.

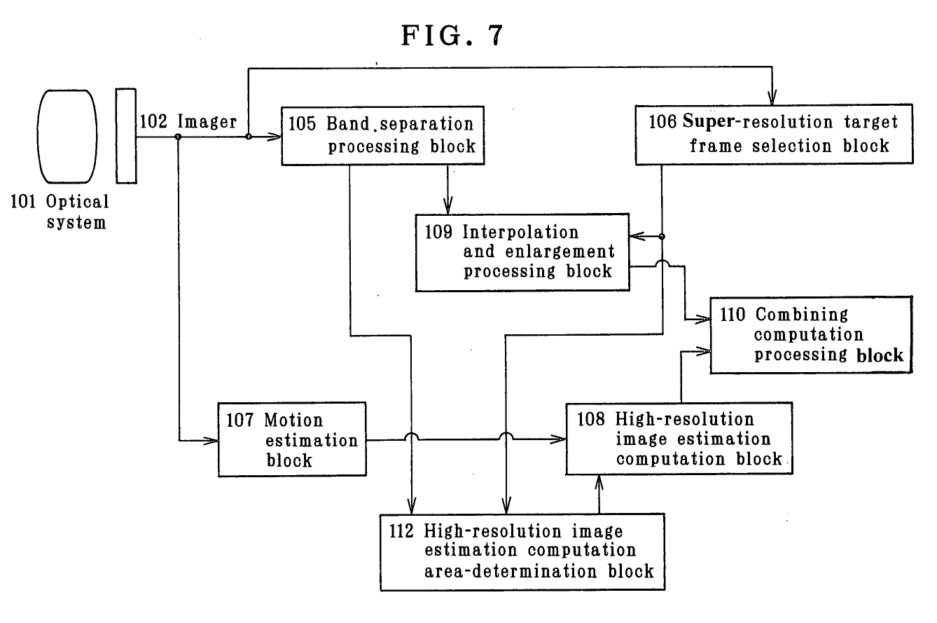

FIG. 7 is illustrative of the architecture of a modification to the first embodiment. Only differences with FIG. 1 are explained. In the architecture of FIG. 7, the signal from the imager 102 is entered directly into the motion estimation block 107. In other words, as far as motion estimation is concerned, the band separation is not always necessary as shown in FIG. 7; it is acceptable to use the original image signal obtained by making the image optically formed at the imager 102 spatially discrete for sampling. In the architecture of FIG. 7, all signals from the imager 102 are subjected to motion estimation, resulting in an improvement in the accuracy with which the displacement is estimated.

In the example of FIG. 7, too, it is acceptable to use, instead of the image signal acquired at the imager 102, a sampled image signal recorded in a suitable recording medium to implement the high-resolution processing for an image. In this case, the architecture of FIG. 7 is used to carry out the invention for rendering the resolution of an image high, as described with reference to the example of FIG. 1.

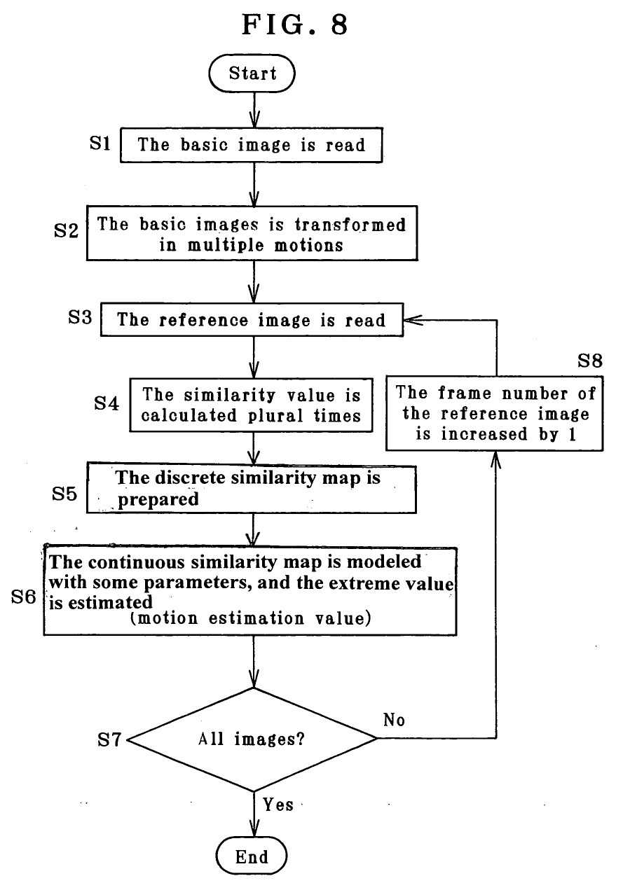

FIG. 8 is a flowchart illustrative of the details of the motion estimation algorithm. FIG. 8 is now explained along the flow of that algorithm. A processing program is started. At S1, one image defining a basis for motion estimation is read. At S2, the basic image is transformed in multiple motions. At S3, one reference image for implementing motion estimation between it and the basic image is read. At S4, a similarity between the sequence of images obtained by transforming the reference image in multiple motions and the reference image is calculated. At S5, a relation between a parameter for transformation motion and the calculated similarity is used to prepare a discrete similarity map.

At S6, the discrete similarity map prepared at S5 is interpolated thereby searching and finding the extreme value for the similarity map. A transformation motion having that extreme value defines an estimation motion. For the purpose of searching the extreme value for the similarity map, there is parabola fitting, spline interpolation or the like. At S7, whether or not motion estimation has been made of all reference images of interest is determined. At S8, if not, the processing of S3 is resumed to keep on the read processing of the next image. When motion estimation has been made of all reference images of interest, the processing program comes to an end.

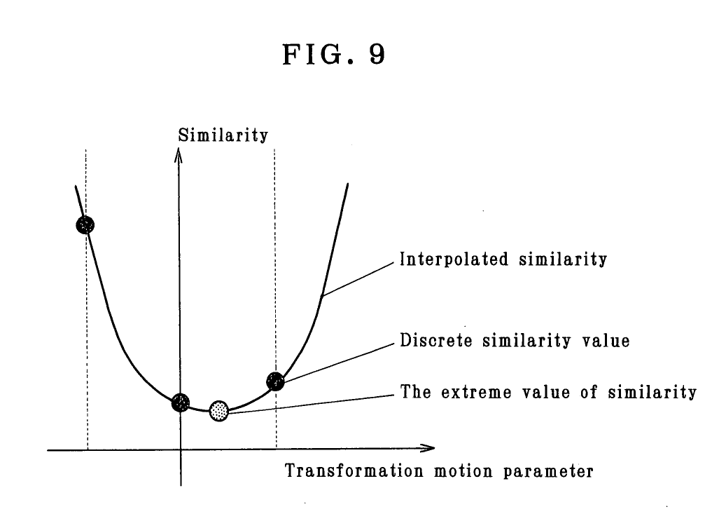

FIG. 9 is illustrative in conception of estimation of the optimal similarity for motion estimation implemented at the motion estimation block 107 described with reference to FIG. 1. More specifically, FIG. 9 shows the results of using three black circles to implement motion estimation by parabola fitting. The ordinate is indicative of a similarity, and the abscissa is indicative of a transformation motion parameter. The smaller the value on the ordinate, the higher the similarity grows, and a gray circle where the value on the ordinate becomes smallest defines an extreme value for the similarity.

FIG. 10 is illustrative in conception of exemplary processing at the high-resolution image computation area-determination block 112. More specifically, FIG. 10(a) is illustrative of a high-frequency component image produced out of the band separation processing block 105, and FIG. 10(b) is illustrative of information about the target frame given out of the super-resolution target frame selection block 106. The high-resolution image computation area-determination block 112 determines from an area having a high-frequency component in FIG. 10(b) an area in the image, to which high-resolution image estimation computation processing is to be applied, and generates from that area information about a “1”-level pixel. Such processing ensures that only with an area having a high-frequency component, high-resolution image estimation computation is implemented.

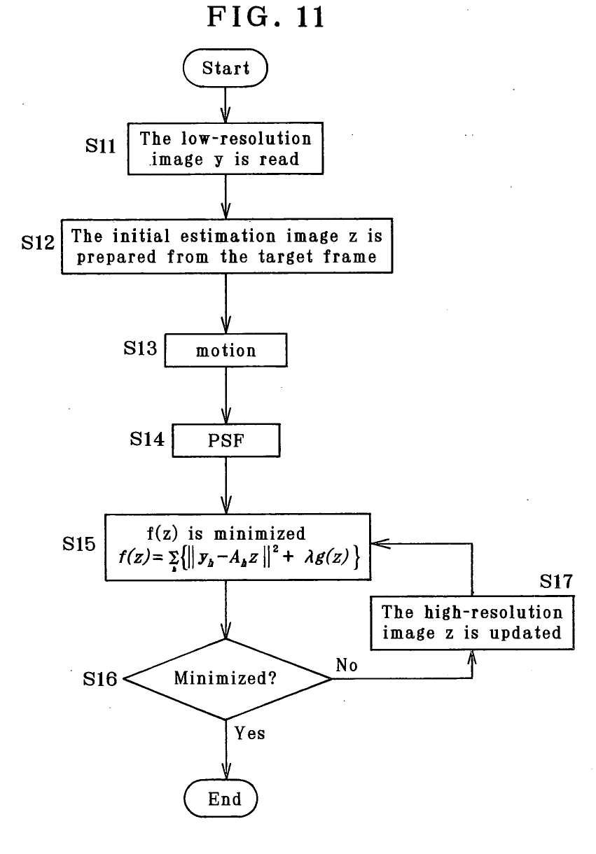

FIG. 11 is a flowchart illustrative of the algorithm for high-resolution image estimation processing. A processing program is started. At S11, multiple low-resolution images n used for high-resolution image estimation are read (n≧1). At S12, an initial high-resolution image is prepared by interpolation, assuming any one of multiple low-resolution images is the target frame. Optionally, this step may be dispensed with. At S13, an inter-image position relation is clarified by inter-image motion between the target frame determined in advance by some motion estimation technique and other frames. At S14, a point spread function (PSF) is found while bearing an optical transmission function (OTF), imaging characteristics such as CCD aperture or the like in mind. For instance, Gauss function is used for PSF. At S15, an estimation function f(z) is minimized on the basis of information at S3, S4. However, f(z) is represented by

$$f ( z ) = {\sum }_{k} \{ {‖ {y}_{k} - {A}_{k} z ‖}^{2} + λ g ( z ) \}$$

Here, y is a low-resolution image, z is a high-resolution image, and A is an image transformation matrix indicative of an imaging system including an inter-image motion, PSF, etc.; g(z) includes a restraint term or the like, in which care is taken of image smoothness and color correlation; and λ is a weight coefficient. For the minimization of the estimation function, for instance, the steepest descent method is used. At S16, when f(z) found at S15 is already minimized, the processing comes to an end, giving the high-resolution image z. At S17, when f(z) is not yet minimized, the high-resolution image z is updated to resume the processing at S13.

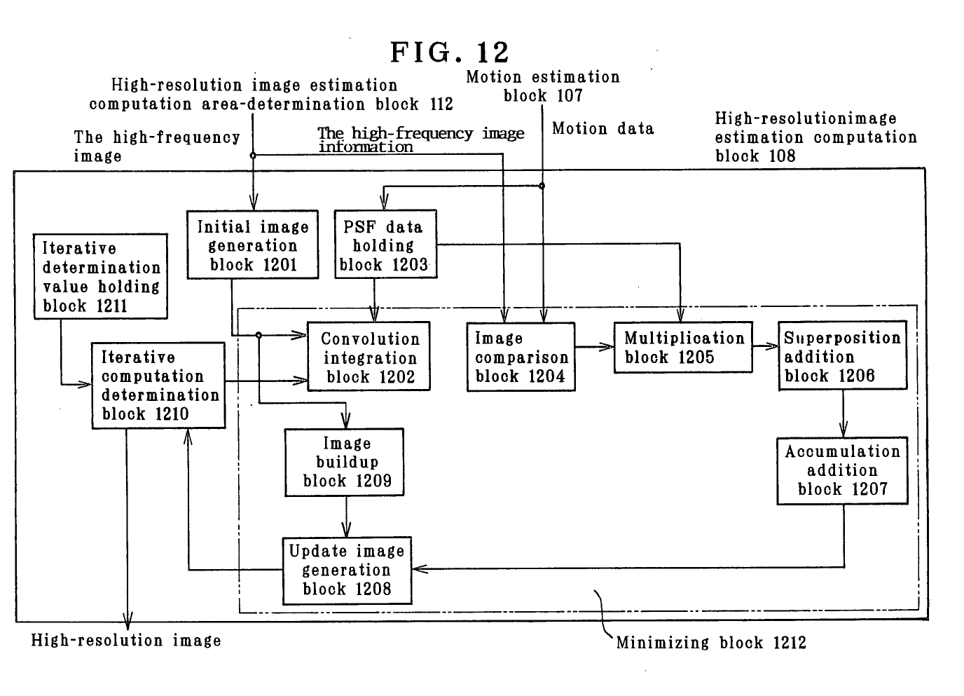

FIG. 12 is illustrative of the architecture of the high-resolution image estimation computation block 18. The high-resolution image estimation processing block 118 is built up of an initial image generation block 1201, a convolution integration block 1202, a PSF data holding block 1203, an image comparison block 1204, a multiplication block 1205, a superposition addition block 1206, an accumulation addition block 1207, an update image generation block 1208, an image buildup block 1209, an iterative computation determination block 1210 and an iterative determination value holding block 1211. A portion encircled by a broken line in FIG. 12 is a minimization processing block 1212 equivalent to the architecture for the minimization of the estimation function f(z) described with reference to S15 in FIG. 11, and PSF data are point spread function data.

In FIG. 12, high-frequency image information about the target frame is given from the high-resolution image estimation computation area-determination block 112 to the initial image generation block 1201, and the image information given here is interpolated and enlarged into an initial image. This initial image is given to the convolution integration block 1202, and subjected to convolution integration along with PSF data sent from the PSF data holding block 1203. And of course, the motion of each frame is here taken into the initial image data. The initial image data are at the same time sent to the image buildup block 1209 for accumulation there. Image data to which convolution computation is applied at the convolution integration block 1201 are sent to the image comparison block 1204 where, on the basis of the motion of each frame found at the motion estimation block, they are compared at a proper coordinate position with taken images given out of the high-resolution image estimation computation area-determination block 112.

The difference compared at the image comparison block 1204 is forwarded to the multiplication block 1205 for multiplication by the value per pixel of the PSF data given out of the PSF data holding block 1203. The results of this computation are sent to the superposition addition block 1206, where they are disposed at the corresponding coordinate positions. Referring here to the image data from the multiplication block 1205, the coordinate positions displace little by little with overlaps, and so those overlaps are added on at the superposition addition block 1206. As the superposition addition of one taken image of data comes to an end, the data are forwarded to the accumulation addition block 1207. At the accumulation addition block 1207, successively forwarded data are built up until the processing of data as many as frames gets done, and one each frame of image data are added on following the estimated motion.

The image data added at the accumulation addition block 1207 are forwarded to the update image generation block 1208. At the same time, the image data built up at the image accumulation block 1209 are given to the update image generation block 1208, and two such image data are added with a weight to generate update image data. The generated update data are given to the iterative computation determination block 1210 to judge whether or not the computation is to be repeated on the basis of the iterative determination value given out of the iterative determination value holding block 1211. When the computation is repeated, the data are forwarded to the convolution integration block 1202 to repeat the aforesaid series of processing, and when not, the generated image data are outputted.

Through the aforesaid series of processing, the image produced out of the iterative computation determination block 1210 has had a resolution higher than that of the taken image. For the PSF data held at the aforesaid PSF data holding block 1203, calculation at proper coordinate positions becomes necessary at the time of convolution integration; the motion for each frame is given to them at the motion estimation block 107 of FIG. 1. A portion encircled by a broken line in FIG. 12 is the minimization processing block 1212 equivalent to the minimization processing for the estimation function f(z) implemented at S15 in FIG. 11.

FIG. 13 is illustrative of the architecture of the combining computation processing block 110 in FIG. 1. In FIG. 13, the estimated high-resolution image information from the high-resolution image estimation computation block 108, and the interpolated and enlarged image information from the interpolation and enlargement processing block 108 is given to the combining computation processing block 110. The bias level added to the high-resolution image given to the combining computation processing block 110 at the time of the band separation of FIG. 2 is taken off. And then, the high-resolution image from which the bias level is subtracted is added to a high-frequency image in the image at the corresponding coordinate position, so that there can be an image synthesized, wherein only a portion having an edge or other high-frequency component is allowed to have a higher resolution. Such a synthesized image is produced out of the combining computation processing block 110.

With the first embodiment of the invention as described above, much faster processing is achievable, because for an image containing lesser high-frequency components, it is unnecessary to implement high-resolution image estimation processing on which there are heavy computation loads; the quantity of computation can be diminished.

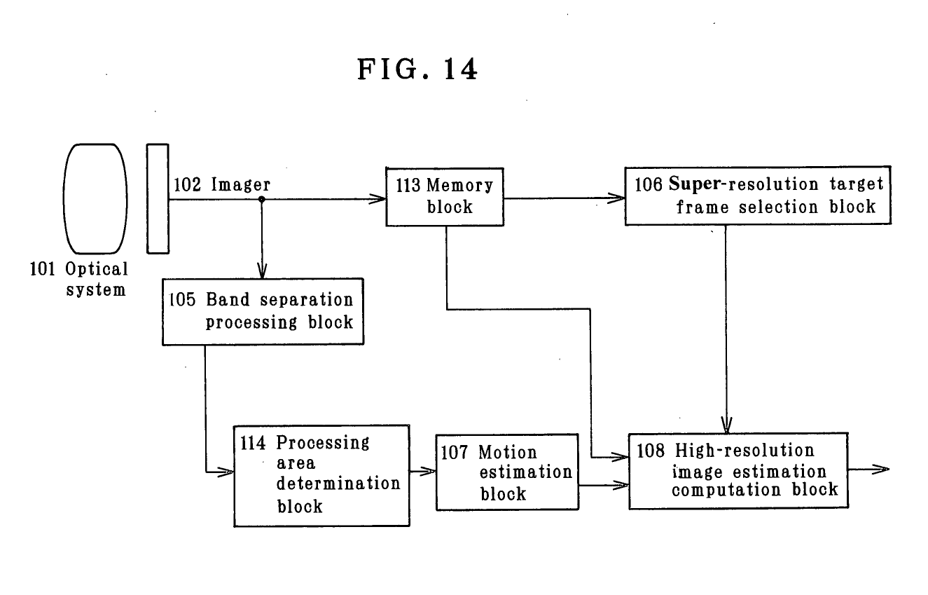

FIG. 14 is illustrative of the architecture of the second embodiment of the invention. In FIG. 14, an optical system 101 forms an optical image on an imager 102, where it is sampled into image data that are in turn given to a band separation processing block 105 and a memory block 113. At the band separation processing block 105, the image is separated into a high-frequency component image and a low-frequency component image, and only information about the high-frequency component image is given to a processing area determination block 114. At the processing area determination block 114, an area in the image which contains a lot more high-frequency component is detected and cut out, and given to a motion estimation block 107. A basic algorithm for the motion estimation block 107 is supposed to be the same as that in the first embodiment.

Here consider a taken image. If the whole of that image moves rather than only a specific object in that image moves, there would then be a uniform motion in that image. In other words, it would not be necessary to make motion estimation for the whole of the image; it would be possible to make motion estimation using only information about an area having a high-frequency component contributable to precise motion estimation. In the second embodiment of the invention, therefore, the motion estimation is implemented using only some area in the image, containing a lot more high-frequency component, and that is used as a motion for the whole image to implement high-resolution image estimation computation. At the processing area determination block 114, one or more areas containing a lot more high frequency are specified from the high-frequency component of the image, and information about that area is cut out and forwarded to the motion estimation block 107. Alternatively, the processing area determination block 114 could operate to calculate luminance information of the high-frequency component, so that an area containing a lot more high-frequency component could be determined from and cut out of that luminance information for forwarding to the motion estimation block 107.

Data about motion estimation, obtained from one area in the image containing a lot more high-frequency component, are given to a high-resolution image estimation computation block 108 and, at the same time, image data temporally stored in the memory block 113 are given to the high-resolution image estimation computation block 108 to implement high-resolution image estimation computation. By doing so, there is a high-resolution estimation image generated. In the second embodiment, the details of motion estimation and high-resolution image estimation computation are supposed to be the same as in the first embodiment.

In the second embodiment shown in FIG. 14, there is no need of using the interpolation and enlargement processing block 109, high-resolution image estimation computation block 112 and combining computation processing block 110 provided in the first embodiment. It is thus possible to diminish the magnitude of processing necessary to obtain high-resolution images.

In the embodiment of FIG. 14, too, it is possible to use, instead of the image signals acquired at the optical system 101 and imager 102, sampled image signals recorded in a suitable recording medium for rendering the resolution of an image high. In this case, the architecture of FIG. 14 may be used as explained with reference to the embodiment of FIGS. 1 and 7 to carry out the invention adapted to render the resolution of an image high.

### POSSIBLE APPLICATION TO THE INDUSTRY

As described above, the present invention provides an imaging system and a process for rendering the resolution of an image high, which ensure high-resolution image estimation computation and the efficient motion estimation computation necessary to this end.

1. An imaging system for electronically obtaining an image of a subject, comprising an optical image-formation means adapted to form the image of the subject, a means adapted to make an optically formed image into a spatially sampled discrete image signal, a means adapted to separate the sampled image signal into multiple component image signals by a spatial frequency, a means adapted to apply interpolation and enlargement processing to a low frequency component image separated by the spatial frequency, a means adapted to estimate a relative displacement between frames, a means adapted to make from multiple frames a frame to which high-resolution image estimation processing is to be applied, a high-resolution image estimation means adapted to estimate a high-resolution image from high-frequency component images each separated from image signals of multiple frames, and a means adapted to combine an interpolated and enlarged image with an image subjected to high-resolution image estimation processing.

2. The imaging system according to claim 1, wherein said sampled image signal is entered in said means adapted to estimate a relative displacement between frames.

3. The imaging system according to claim 1, wherein said means adapted to estimate a relative displacement between frames uses an image signal of at least one component separated into said multiple component image signals to estimate a relative displacement of the subject between frames.

4. An imaging system for electronically obtaining an image of a subject, comprising an optical image-formation means adapted to form the image of the subject, a means adapted to make an optically formed image into a spatially sampled discrete image signal, a means adapted to separate the sampled image signal into multiple component image signals by a spatial frequency, a means adapted to estimate a relative displacement between frames, an image storage means adapted to provide a temporal storage of the image signal, a means adapted to select from multiple frames a frame to which high-resolution image estimation processing is to be applied, a high-resolution image estimation means adapted to estimate a high-resolution image from image signals of multiple frames, an image information identification means adapted to refer to at least one image signal of multiple component image signals separated by said spatial frequency to identify image information, and a means adapted to use information about the image identified by said image information identification means to set an area in an image, wherein information about said area in an image is used to estimate a high-resolution image.

5. The imaging system according to claim 4, wherein said image information identification means is a means adapted to extract a high-frequency component from the image.

6. The imaging system according to claim 4, wherein said image information identification means is adapted to refer to luminance information of at least one image signal of said multiple component image signals separated by said spatial frequency.

7. A process for reconstructing a high resolution image from sampled image signals, comprising steps of separating a sampled image signal into multiple component image signals by a spatial frequency, applying interpolation and enlargement processing to a low-frequency component image separated by the spatial frequency, estimating a relative displacement between frames by a displacement estimation means, selecting from multiple frames a frame to which high-resolution image estimation processing is to be applied, estimating a high-resolution image from high-frequency component images each separated from image signals of multiple frames, and combining an interpolated and enlarged image with an image to which high-resolution image estimation processing is applied.

8. The process for reconstructing a high resolution image according to claim 7, wherein said sampled image signal is entered in the displacement estimation means adapted to estimate a relative displacement between frames.

9. The process for reconstructing a high resolution image according to claim 7, wherein said step of estimating a relative displacement between frames uses an image signal of at least one component separated into said multiple component image signals to estimate a relative displacement between frames.

10. A process for reconstructing a high resolution image signal from sampled image signals, comprising steps of separating the sampled image signals into multiple component image signals by a spatial frequency, estimating a relative displacement between frames, providing a temporal storage of an image signal, selecting from multiple frames a frame to which high-resolution image estimation processing is to be applied, estimating a high-resolution image from image signals of multiple frames, referring to at least one image signal of said multiple component image signals separated by the spatial frequency to identify information about an image by an identification means, and setting an area in an image by said identification means, wherein said step of estimating a high-resolution image uses an area about said area in an image to estimate a high-resolution image.

11. The process for reconstructing a high resolution image signal from sampled image signals according to claim 10, wherein at said step of identifying said information about an image, a high-frequency component is extracted from the image.

12. The process for reconstructing a high resolution image signal from sampled image signals according to claim 10, wherein at said step of identifying said information about an image, reference is made to luminance information of at least one image signal of multiple component image signals separated by the spatial frequency.
